(19) United States
(12) Patent Application Publication
(10) Pub. No.: US 2014/0357380 A1
(43) Pub. Date: Dec. 4, 2014

(54) Systems and Methods for Equipping Game Props

(71) Applicant: Tencent Technology (Shenzhen) Company Limited, Shenzhen (CN)

(72) Inventor: Junming Wang, Shenzhen (CN)

(21) Appl. No.: 14/302,595

(22) Filed: Jun. 12, 2014

Related U.S. Application Data
(63) Continuation of application No. PCT/CN2014/070053, filed on Jan. 3, 2014.

(30) Foreign Application Priority Data
Jun. 4, 2013 (CN) 201310219070.1

(51) Int. Cl. A63F 13/69; A63F 13/77

(52) U.S. Cl. CPC A63F 13/69; A63F 13/77
USPC 463/43

(57) ABSTRACT

Systems and methods are provided for equipping game props. For example, a first prop of a game user is detected, the first prop not being equipped for the game user; the first prop is compared with a second prop of the game user, the second prop being equipped for the game user and being in a same category as the first prop; and in response to the first prop having a better performance than the second prop, the first prop is equipped for the game user.

### CROSS-REFERENCES TO RELATED APPLICATIONS

This application claims priority to Chinese Patent Application No. 201310219070.1, filed Jun. 4, 2013, incorporated by reference herein for all purposes.

### BACKGROUND OF THE INVENTION

Certain embodiments of the present invention are directed to computer technology. More particularly, some embodiments of the invention are related to electronic games. Merely by way of example, some embodiments of the invention have been applied to online games. But it would be recognized that the invention has a much broader range of applicability.

Nowadays, online games become increasingly popular because multiple users can concurrently play together online and engage in real-time interaction. Usually, an online gaming system includes a game server and multiple game clients for users. In a game, the game server sends related data, such as game scenarios, Player Control (PC) characters and Non-Player Control (NPC) characters to a game client, and a user plays the game through real-time interactions between the game client and the game server.

To make games more entertaining, an online gaming system generally provides a variety of props with different functions and attributes. For example, common props include coins, equipment and weapons. A game user or a game character controlled by the game user can obtain a prop through a wide range of means, for example, fulfilling a game task, killing an NPC character, or purchasing the prop. The game user or the game character controlled by the game user can equip the obtained prop and then use it in the game.

A conventional technology for equipping a game prop includes the following: a game user first opens a backpack column for displaying all props obtained by the game user or a game character controlled by the game user, and then selects a desired prop to be equipped from the backpack column. The conventional technology involves complicated operations and low artificial intelligence, and often cannot satisfy requirements for real-time interactions related to online gaming systems. In addition, the game server provides a large number of various props which vary in function and attributes. It usually takes a game user a long time to select a desired prop to equip. Moreover, the game user has different familiarity with respect to different props, which usually leads to low accuracy of equipping a prop.

Hence it is highly desirable to improve the techniques for equipping a game prop.

### BRIEF SUMMARY OF THE INVENTION

According to one embodiment, a method is provided for equipping game props. For example, a first prop of a game user is detected, the first prop not being equipped for the game user; the first prop is compared with a second prop of the game user, the second prop being equipped for the game user and being in a same category as the first prop; and in response to the first prop having a better performance than the second prop, the first prop is equipped for the game user.

According to another embodiment, a device for equipping game props includes a prop-detection unit, a prop-performance-comparison unit, and a prop-equipping unit. The prop-detection unit is configured to detect a first prop of a game user, the first prop not being equipped for the game user. The prop-performance-comparison unit is configured to compare the first prop with a second prop of the game user, the second prop being equipped for the game user and being in a same category as the first prop. The prop-equipping unit is configured to, in response to the first prop having a better performance than the second prop, equip the first prop for the game user.

According to yet another embodiment, a non-transitory computer readable storage medium comprises programming instructions for equipping game props. The programming instructions are configured to cause one or more data processors to execute certain operations. For example, a first prop of a game user is detected, the first prop not being equipped for the game user; the first prop is compared with a second prop of the game user, the second prop being equipped for the game user and being in a same category as the first prop; and in response to the first prop having a better performance than the second prop, the first prop is equipped for the game user.

For example, the systems and methods described herein are configured to enable automatic equipping of a game prop so as to simplify and speed up prop-equipping operations and reduce the time for equipping props. In another example, the systems and methods described herein are configured to render prop-equipping more accurate and more intelligent.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for equipping game props according to one embodiment of the present invention;

FIG. 2 is a simplified diagram showing a method for equipping game props according to another embodiment of the present invention;

FIG. 3 is a simplified diagram showing a device for equipping game props according to an embodiment of the present invention; and

FIG. 4 is a simplified diagram showing a device for equipping game props according to another embodiment of the present invention.

### DETAILED DESCRIPTION OF THE INVENTION

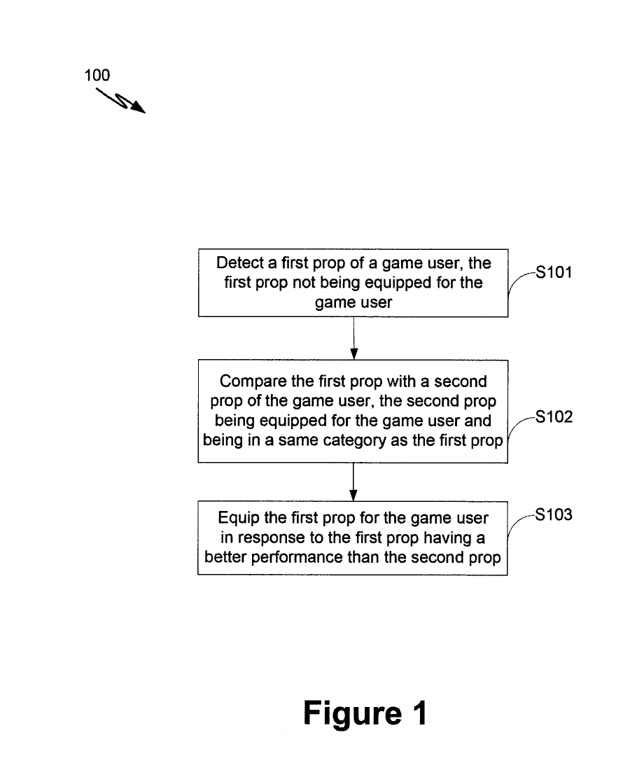

FIG. 1 is a simplified diagram showing a method for equipping game props according to one embodiment of the present invention. This diagram is merely an example, which should not unduly limit the scope of the claims. One of ordinary skill in the art would recognize many variations, alternatives, and modifications. The method 100 includes at least the process S101 for detecting a first prop of a game user, the process S102 for comparing the first prop with a second prop of the game user, and the process S103 for equipping the first prop for the game user in response to the first prop having a better performance than the second prop.

According to one embodiment, during the process S101, the first prop of the game user is detected. Herein “first” neither indicates a sequence nor implies that a second prop must exist. “First” is used here merely for purpose of referring to and differentiating between different props. For example, the game user includes a character controlled by the game user. As an example, the first prop refers to a prop that is obtained by the game user but is not equipped. The game user may obtain game props through multiple means, including fulfilling a game task, purchasing the props, or other suitable means. For example, in response to the game user fulfilling a game task, the game server generates a prop. The game user sends, through a game client, a prop-pickup instruction to the game server, and the game server saves the prop corresponding to the prop-pickup instruction to a database of the game user. In another example, in response to the game user entering a prop-purchase instruction, the game server saves a prop corresponding to the prop-purchase instruction to a database of the game user. Once a prop is saved to the database of the game user, the game user obtains the prop. For example, the database of the game user is used to store game data related to the game user. The game data related to the game user includes the game user's ID, props obtained by the game user, props equipped for the game user, a game level associated with the game user, and the amount of time the gamer spends playing the game. In certain embodiments, each prop includes one or more attributes, and each attribute has one or more attribute values. The performance of a prop is associated with the attributes of the prop and the related attribute values.

According to another embodiment, during the process S102, the first prop is compared with the second prop of the game user. For example, the second prop refers to a prop that has been equipped for the game user and belongs to a same category as the first prop. All props provided by the game server may be classified into different categories beforehand according to functions and performance of the props, e.g., through a single-level classification or a multi-level classification. For example, the props are classified as offense props, defense props, and delay props, etc.

According to yet another embodiment, the process for comparing the first prop with the second prop includes operations A1: a first category of the first prop and a second category of the second prop are acquired. In some embodiments, whether an attribute value associated with a particular attribute of a prop represents a better performance or a worse performance of the prop is determined based on at least information associated with the category of the prop. As an example, an offense prop includes attributes A, B and C. The larger the attribute values of the attributes A and B, the better performance the offense prop has, and the larger the attribute value of the attribute C, the worse performance the offense prop has. In another example, a defense prop includes attributes A, D and E. The larger the attribute values of A and D, the worse performance the defense prop has, and the larger the attribute value of E, the better performance the defense prop has. For example, the attribute value of each attribute of a prop in each category can be set to indicate the better/worse performance of the prop in accordance with different game requirements.

According to yet another embodiment, the process for comparing the first prop with the second prop further includes operations A2: one or more first attribute values associated with the first attributes are compared with one or more second attribute values associated with the second attributes based on at least information associated with the first category and the second category. A first number of the first attribute values that are better than the corresponding second attribute values and a second number of the first attribute values that are worse than the corresponding second attribute values are determined. In response to the first number being larger than the second number, it is determined that the first prop has a better performance than the second prop. Otherwise, it is determined that the first prop has a worse performance than the second prop. For example, in the operations of comparing the attribute values of the first prop with the corresponding attribute values of the second prop, if the second prop does not have a particular attribute of the first prop, it is determined that the attribute value of the particular attribute of the first prop is better than that of the second prop. On the other hand, if the first prop does not have a specific attribute of the second prop, it is determined that the attribute value of the specific attribute of the first prop is worse than that of the second prop.

In certain embodiments, assuming attributes and related attribute values of the first prop M are shown in Table 1, and attributes and related attribute values of the second prop N are shown in Table 2.

TABLE 1
First prop M

| | |
|---|---|
| Attribute A | Value 1 |
| Attribute B | Value 2 |
| Attribute C | Value 5 |

TABLE 2
Second prop N

| | |
|---|---|
| Attribute A | Value 2 |
| Attribute B | Value 4 |
| Attribute C | Value 6 |

In one embodiment, the attribute values of the attributes A, B and C of the first prop are compared with the attribute values of the attributes A, B and C of the second prop respectively to determine whether the attribute values of the first prop are better than the corresponding attribute values of the second prop. As an example, the smaller the attribute values of the attributes A, B and C of a particular prop, the better performance the particular prop has. After comparison, it is determined that the attribute values of the attributes A, B and C of the first prop are better than the corresponding attribute values of the second prop, and thus, the performance of the first prop is determined to be better than that of the second prop, in some embodiments. For example, if the attribute values of two attributes of the first prop are better than the corresponding attribute values of the second prop, the performance of the first prop is determined to be better than that of the second prop. In another example, if the attribute value of only one attribute of the first prop is better than the corresponding attribute value of the second prop, the performance of the first prop is determined to be worse than that of the second prop.

In another embodiment, the process for comparing the first prop with the second prop further includes operations B1: one or more first weights are assigned to one or more first attributes of the first prop, and one or more second weights are assigned to one or more second attributes of the second prop. For example, the first weights are assigned to different attributes of the first prop based on the influence of each attribute on the performance of the first prop. As an example, a larger weight is set for an attribute that has a greater influence on the performance of the first prop. In another example, the first weights are assigned to different attributes of the first prop according to different game scenarios. In some embodiments, the first weights are assigned to different attributes of the first prop based on other requirements. Similar to what are described for the first prop, the second weights are assigned to different attributes of the second prop.

In yet another embodiment, the process for comparing the first prop with the second prop further includes operations B2: one or more first weighted attribute values of the first prop are determined based on at least information associated with the first attribute values and the first weights, and one or more second weighted attributes of the second prop are determined based on at least information associated with the second attribute values and the second weights. For example, assuming attributes and related attribute values of the first prop M are shown in Table 3, and attributes and related attribute values of the second prop N are shown in Table 4.

TABLE 3
First prop M

| | | |
|---|---|---|
| Attribute A | Value 1 | Weight 0.1 |
| Attribute B | Value 2 | Weight 0.5 |
| Attribute C | Value 5 | Weight 0.4 |

TABLE 4
Second prop N

| | | |
|---|---|---|
| Attribute A | Value 2 | Weight 0.1 |
| Attribute B | Value 4 | Weight 0.5 |
| Attribute C | Value 6 | Weight 0.4 |

For example, the weighted attribute value of the first prop is equal to 1×0.1+3×0.5+5×0.4=3.6. The weighted attribute value of the second prop is equal to 2×0.1+4×0.5+6×0.4=4.6.

In yet another embodiment, the process for comparing the first prop with the second prop further includes operations B3: a first category of the first prop and a second category of the second prop are acquired. For example, whether a weighted attribute value of a prop represents a better performance or a worse performance of the prop is determined based on at least information associated with the category of the prop. As an example, the larger the weighted attribute value of an offense prop, the worse performance the offense prop has. In another example, the larger the weighted attribute value of a defense prop, the better performance the defense prop has.

In yet another embodiment, the process for comparing the first prop with the second prop further includes operations B4: the first weighted attribute values of the first prop are compared with the second weighted attribute values of the second prop based on at least information associated with the first category and the second category, and whether the first prop has a better performance than the second prop is determined based on at least information associated with the comparison of the first weighted attribute values and the second weighted attribute values. In some embodiments, it is determined that the higher the weighted attribute value of a prop is, the better performance the prop has, based on the first category and the second category. For example, if the one or more first weighted attribute values of the first prop are larger than the one or more second weighted attribute values of the second prop, the performance of the first prop is better than that of the second prop. Otherwise, the performance of the first prop is worse than that of the second prop. In certain embodiments, it is determined that the higher the weighted attribute value of a prop is, the worse performance the prop has, based on the first category and the second category. For example, if the one or more first weighted attribute values of the first prop are larger than the one or more second weighted attribute values of the second prop, the performance of the first prop is worse than that of the second prop. Otherwise, the performance of the first prop is better than that of the second prop.

According to one embodiment, during the process S103, the first prop is equipped for the game user in response to the first prop having a better performance than the second prop. For example, if the performance of the first prop is worse than that of the second prop, then the first prop is not equipped. In another example, if the performance of the first prop is better than that of the second prop, the second prop is cancelled, and the first prop is equipped for the game user. Specifically, the process for canceling the second prop and equipping the first prop for the game user includes: deleting the second prop from a field for recording all props equipped for the game user in a database of the game user, and adding the first prop to the field for recording the props equipped for the game user in the database of the game user.

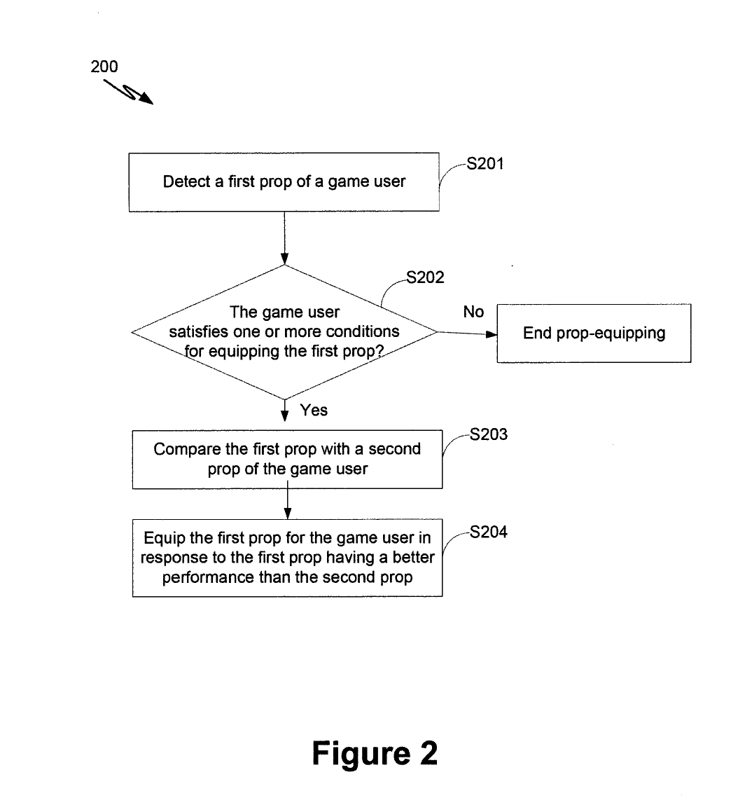

FIG. 2 is a simplified diagram showing a method for equipping game props according to another embodiment of the present invention. This diagram is merely an example, which should not unduly limit the scope of the claims. One of ordinary skill in the art would recognize many variations, alternatives, and modifications. The method 200 includes at least the process S201 for detecting a first prop of a game user, the process S202 for determining whether the game user satisfies one or more conditions for equipping the first prop, the process S203 for comparing the first prop with a second prop of the game user, and the process S204 for equipping the first prop for the game user in response to the first prop having a better performance than the second prop.

According to one embodiment, the process S201 is similar to the process S101. For example, during the process S202, if it is determined that the game user satisfies the one or more conditions for equipping the first prop, the process S203 is executed; otherwise, the prop-equipping ends. The one or more conditions for equipping the first prop may be determined according to specific game requirements. For example, the conditions for equipping the first prop includes: the game user reaching a predetermined level, a game character controlled by the game user falling within a predetermined character scope, or other suitable conditions. According to another embodiment, the process S203 is similar to the process S102. For example, the process S204 is similar to the process S103.

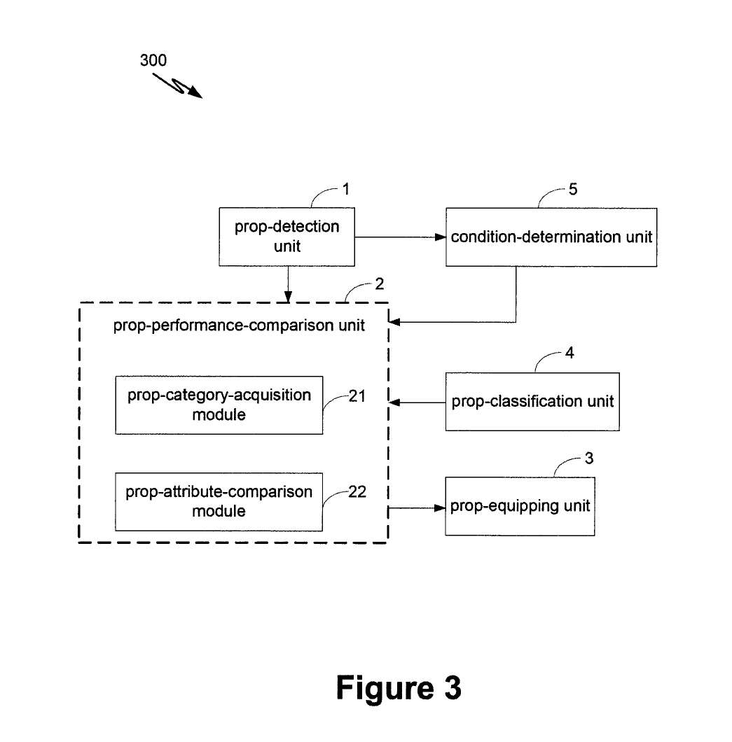

FIG. 3 is a simplified diagram showing a device for equipping game props according to one embodiment of the present invention. This diagram is merely an example, which should not unduly limit the scope of the claims. One of ordinary skill in the art would recognize many variations, alternatives, and modifications. The device 300 includes a prop-detection unit 1, a prop-performance-comparison unit 2, and a prop-equipping unit 3.

According to one embodiment, the prop-detection unit 1 is configured to detect a first prop of a game user, the first prop not being equipped for the game user. For example, the game user obtains game props through multiple means, including fulfilling a game task, purchasing the props, or other suitable means. In another example, the prop-performance-comparison unit 2 is configured to compare the first prop with a second prop of the game user, the second prop being equipped for the game user and being in a same category as the first prop. In yet another example, the prop-equipping unit 3 is configured to, in response to the first prop having a better performance than the second prop, equip the first prop for the game user.

According to another embodiment, the device 300 includes a prop-classification unit 4 configured to classify classifying multiple third props, the third props including the first prop and the second prop. For example, the prop-performance-comparison unit 2 includes a prop-category-acquisition module 21 configured to acquire a first category of the first prop and a second category of the second prop, the first prop being associated with one or more first attributes, the second prop being associated with one or more second attributes. As an example, the prop-performance-comparison unit 2 further includes a prop-attribute-comparison module 22 configured to compare one or more first attribute values associated with the first attributes and one or more second attribute values associated with the second attributes based on at least information associated with the first category and the second category, determine a first number of the first attribute values that are higher than the corresponding second attribute values, determine a second number of the first attribute values that are lower than the corresponding second attribute values, and in response to the first number being larger than the second number, determine that the first prop has a better performance than the second prop. For example, in the operations of comparing the attribute values of the first prop with the corresponding attribute values of the second prop, if the second prop does not have a particular attribute of the first prop, it is determined that the attribute value of the particular attribute of the first prop is better than that of the second prop. On the other hand, if the first prop does not have a specific attribute of the second prop, it is determined that the attribute value of the specific attribute of the first prop is worse than that of the second prop.

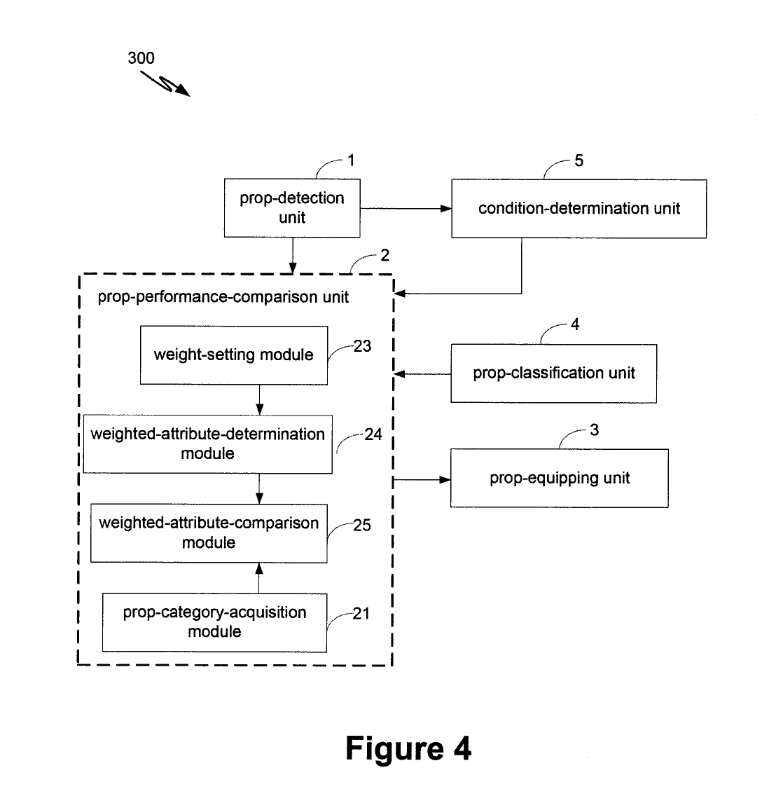

FIG. 4 is a simplified diagram showing the device 300 for equipping game props according to another embodiment of the present invention. This diagram is merely an example, which should not unduly limit the scope of the claims. One of ordinary skill in the art would recognize many variations, alternatives, and modifications.

According to one embodiment, the prop-performance-comparison unit 2 includes a weight-setting module 23 configured to assign one or more first weights to one or more first attributes of the first prop and assign one or more second weights to one or more second attributes of the second prop, the first attributes being associated with one or more first attribute values, the second attributes being associated with one or more second attribute values. For example, the prop-performance-comparison unit 2 further includes a weighted-attribute-determination module 24 configured to determine one or more first weighted attribute values of the first prop based on at least information associated with the first attribute values and the first weights, and determine one or more second weighted attributes of the second prop based on at least information associated with the second attribute values and the second weights. In another example, the prop-performance-comparison unit 2 further includes a category-acquisition module 21 configured to acquire a first category of the first prop and a second category of the second prop, and a weighted-attribute-comparison module 25 configured to compare the first weighted attribute values of the first prop and the second weighted attribute values of the second prop based on at least information associated with the first category and the second category, and determine whether the first prop has a better performance than the second prop based on at least information associated with the comparison of the first weighted attribute values and the second weighted attribute values.

Referring to FIG. 3 and/or FIG. 4, the device 300 further includes a condition-determination unit 5 configured to determine whether the game user satisfies one or more conditions for equipping the first prop. For example, the prop-performance-comparison unit 1 is configured to compare the first prop with the second prop of the game user in response to the game user satisfying the one or more conditions for equipping the first prop. The one or more conditions for equipping the first prop may be determined according to specific game requirements. For example, the conditions for equipping the first prop includes: the game user reaching a predetermined level, a game character controlled by the game user falling within a predetermined character scope, or other suitable conditions.

In some embodiments, the device 300 is applied to portable electronic devices, such as video game consoles, or applied to personal computers. For example, the device 300 is a software unit, a hardware unit or a unit combining both software and hardware that runs on a portable electronic device or a personal computer. In another example, the device 300 is integrated into a portable electronic device or a personal computer as an independently attached unit, or is run in certain application systems of the portable electronic device or the personal computer.

According to one embodiment, a method is provided for equipping game props. For example, a first prop of a game user is detected, the first prop not being equipped for the game user; the first prop is compared with a second prop of the game user, the second prop being equipped for the game user and being in a same category as the first prop; and in response to the first prop having a better performance than the second prop, the first prop is equipped for the game user. For example, the method is implemented according to at least FIG. 1, and/or FIG. 2.

According to another embodiment, a device for equipping game props includes a prop-detection unit, a prop-performance-comparison unit, and a prop-equipping unit. The prop-detection unit is configured to detect a first prop of a game user, the first prop not being equipped for the game user. The prop-performance-comparison unit is configured to compare the first prop with a second prop of the game user, the second prop being equipped for the game user and being in a same category as the first prop. The prop-equipping unit is configured to, in response to the first prop having a better performance than the second prop, equip the first prop for the game user. For example, the device is implemented according to at least FIG. 3, and/or FIG. 4.

According to yet another embodiment, a non-transitory computer readable storage medium comprises programming instructions for equipping game props. The programming instructions are configured to cause one or more data processors to execute certain operations. For example, a first prop of a game user is detected, the first prop not being equipped for the game user; the first prop is compared with a second prop of the game user, the second prop being equipped for the game user and being in a same category as the first prop; and in response to the first prop having a better performance than the second prop, the first prop is equipped for the game user. For example, the storage medium is implemented according to at least FIG. 1, and/or FIG. 2.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method for equipping game props, the method comprising:
detecting a first prop of a game user, the first prop not being equipped for the game user;
comparing the first prop with a second prop of the game user, the second prop being equipped for the game user and being in a same category as the first prop; and
in response to the first prop having a better performance than the second prop, equipping the first prop for the game user.

2. The method of claim 1, further comprising:
classifying multiple third props, the third props including the first prop and the second prop.

3. The method of claim 1, wherein the comparing the first prop with a second prop of the game user includes:
acquiring a first category of the first prop and a second category of the second prop, the first prop being associated with one or more first attributes, the second prop being associated with one or more second attributes;
comparing one or more first attribute values associated with the first attributes and one or more second attribute values associated with the second attributes based on at least information associated with the first category and the second category;
determining a first number of the first attribute values that are better than the corresponding second attribute values;
determining a second number of the first attribute values that are worse than the corresponding second attribute values; and
in response to the first number being larger than the second number, determining that the first prop has a better performance than the second prop.

4. The method of claim 1, wherein the comparing the first prop with a second prop of the game user includes:
assigning one or more first weights to one or more first attributes of the first prop, the first attributes being associated with one or more first attribute values;
assigning one or more second weights to one or more second attributes of the second prop, the second attributes being associated with one or more second attribute values;
determining one or more first weighted attribute values of the first prop based on at least information associated with the first attribute values and the first weights;
determining one or more second weighted attributes of the second prop based on at least information associated with the second attribute values and the second weights;
acquiring a first category of the first prop and a second category of the second prop;
comparing the first weighted attribute values of the first prop and the second weighted attribute values of the second prop based on at least information associated with the first category and the second category; and
determining whether the first prop has a better performance than the second prop based on at least information associated with the comparison of the first weighted attribute values and the second weighted attribute values.

5. The method of claim 1, further comprising:
determining whether the game user satisfies one or more conditions for equipping the first prop;
wherein the first prop is compared with the second prop of the game user in response to the game user satisfying the one or more conditions for equipping the first prop.

6. A device for equipping game props, the device comprising:
a prop-detection unit configured to detect a first prop of a game user, the first prop not being equipped for the game user;
a prop-performance-comparison unit configured to compare the first prop with a second prop of the game user, the second prop being equipped for the game user and being in a same category as the first prop; and
a prop-equipping unit configured to, in response to the first prop having a better performance than the second prop, equip the first prop for the game user.

7. The device of claim 6, further comprising:
a prop-classification unit configured to classify classifying multiple third props, the third props including the first prop and the second prop.

8. The device of claim 6, where the prop-performance-comparison unit includes:
a prop-category-acquisition module configured to acquire a first category of the first prop and a second category of the second prop, the first prop being associated with one or more first attributes, the second prop being associated with one or more second attributes; and
a prop-attribute-comparison module configured to compare one or more first attribute values associated with the first attributes and one or more second attribute values associated with the second attributes based on at least information associated with the first category and the second category, determine a first number of the first attribute values that are higher than the corresponding second attribute values, determine a second number of the first attribute values that are lower than the corresponding second attribute values, and in response to the first number being larger than the second number, determine that the first prop has a better performance than the second prop.

9. The device of claim 6, wherein the prop-performance-comparison unit includes:
a weight-setting module configured to assign one or more first weights to one or more first attributes of the first prop and assign one or more second weights to one or more second attributes of the second prop, the first attributes being associated with one or more first attribute values, the second attributes being associated with one or more second attribute values;
a weighted-attribute-determination module configured to determine one or more first weighted attribute values of the first prop based on at least information associated with the first attribute values and the first weights, and determine one or more second weighted attributes of the second prop based on at least information associated with the second attribute values and the second weights;
a category-acquisition module configured to acquire a first category of the first prop and a second category of the second prop; and
a weighted-attribute-comparison module configured to compare the first weighted attribute values of the first prop and the second weighted attribute values of the second prop based on at least information associated with the first category and the second category, and determine whether the first prop has a better performance than the second prop based on at least information associated with the comparison of the first weighted attribute values and the second weighted attribute values.

10. The device of claim 6, further comprising:
a condition-determination unit configured to determine whether the game user satisfies one or more conditions for equipping the first prop;
wherein the prop-performance-comparison unit is configured to compare the first prop with the second prop of the game user in response to the game user satisfying the one or more conditions for equipping the first prop.

11. The device of claim 6, further comprising:
one or more data processors; and
a computer-readable storage medium;
wherein one or more of the prop-detection unit, the prop-performance-comparison unit, and the prop-equipping unit are stored in the storage medium and configured to be executed by the one or more data processors.

12. A non-transitory computer readable storage medium comprising programming instructions for equipping game props, the programming instructions configured to cause one or more data processors to execute operations comprising:
detecting a first prop of a game user, the first prop not being equipped for the game user;
comparing the first prop with a second prop of the game user, the second prop being equipped for the game user and being in a same category as the first prop; and
in response to the first prop having a better performance than the second prop, equipping the first prop for the game user.
